(19) United States
(12) Patent Application Publication
(10) Pub. No.: US 2017/0347635 A1
(43) Pub. Date: Dec. 7, 2017

(54) Fishing Lure

(71) Applicant: Thomas F. Sandefur, Kuttawa, KY (US)

(72) Inventor: Thomas F. Sandefur, Kuttawa, KY (US)

(21) Appl. No.: 15/330,186

(22) Filed: Aug. 20, 2016

Related U.S. Application Data
(63) Continuation-in-part of application No. 14/999,606, filed on Jun. 1, 2016.
(60) Provisional application No. 62/392,518, filed on Jun. 3, 2016.

(51) Int. Cl. A01K 85/10; A01K 85/02

(52) U.S. Cl. CPC A01K 85/10; A01K 85/02

(57) ABSTRACT

A fishing lure frame comprising a V-shaped frame having an aperture or loop formed at a vertex of the V-shaped member, the V-shaped member having a first leg and an upper second leg joined at the vertex, the first leg including a lure body extending from a distal end thereof with a hook extending from a distal end of the body and a skirt attaching at a collar formed by a reduced diameter medial portion of the body, the second leg being about three-fourths as long as the first leg and extending at a selected angle of from between 60-120 degrees from the first leg, the second leg extending in spaced apart alignment with the first leg and the second leg including a rotatable bladed attaching to a distal end thereof, the lure body including a plurality of transverse longitudinal members extending from the tip thereof including distal ends having rotatable blades connecting thereto.

### CROSS REFERENCES TO RELATED APPLICATIONS

This is a Continuation-In-Part of U.S. application Ser. No. 14/999,606 filed on Jun. 1, 2016 and claims priority from U.S. Provisional Application 62/392,518 filed on Jun. 3, 2016 both of which are incorporated herein in its entirety.

### TECHNICAL FIELD

The present invention relates to the field of fishing lures and more particularly to artificial lures, containing more than one bait and hook, which mimic live bait motion while moving through the water.

### BACKGROUND OF THE INVENTION

Artificial lures often contain portions which resemble small fish, frogs, insects or worms. Such lures often include a spinning portion which reflects light in hopes that the flickering will also attract fish. The shape of such lures often leads to unnatural wobbling, spinning or jerking of the entire lure while moving thorough the water, which may tend to scare fish away.

Attempts at designs which encourage a more natural movement of the lure have included tail members which impart a wiggle as a lure moves through the water. Some designs which are exemplary of such attempts include a tail which extends outward from the body of the lure, a tail with a curved end defining a J-shape, or a tail which includes a forward canted wing piece which fluctuates as the bait is pulled forward and causes the bait to flutter. Other lures include a rigid, canted spoon or wall fixed near a front face of a lure and jutting forward out from the face causing the lure to zig-zag violently while moving through the water. Some examples include a plurality of body parts articulatingly linked together by eyelets or chain links. Still other examples comprise a spoon shaped body which either spins or darts about while being pulled through the water.

### DESCRIPTION OF THE RELATED ART

U.S. Pat. No. 4,998,373 for DOUBLE HOOK LURE by Braswell issued on Mar. 12, 1991 and is incorporated by reference herein teaches a lure with a planar wire frame with a forward eye and trailing hooks which can be fitted with various baits such as artificial worms, feathers, fish, and so on. Braswell includes a shiny spinner element and uses double hooks rather than single hooks which tend to catch more weeds and moss than single hook units. Braswell teaches non-similar baits on the hooks. The present invention uses similar or identical baits to mimic a ‘school’ appearance and does not include shiny spinning elements.

U.S. Pat. No. 3,673,726 for FISH LURE by La Montagne issued on Jul. 4, 1972 teaches a coplanar frame with an eye at one end and at the other end are two similar or identical baits but with treble hooks pivotally attached at the two ends of the frame. Treble hooks catch more weeds and moss when pulled through the water. The present invention contains two individual hooks rigidly attached, one to each end of a V-shaped wire frame.

U.S. Pat. No. 4,671,007 for FISHING LURE DEVICE by Stancyk issued on Jun. 9, 1987 teaches a V-shaped wire frame with an eye at the vertex with a hook and bait pivotally connected at each end of the V. The points of each hook face inward toward a center of the V-shaped frame. Stancyk provides for pivotally connected hooks unlike the present invention which contains a V-shaped frame with rigidly attached hooks.

U.S. Pat. No. 6,155,000 for RATTLE BAIT FISHING LURE by Raven croft issued on Dec. 5, 2000 teaches an approximately V-shaped frame with a eyelet for line attachment at the vertex of the V, a weighted hook and bait rigidly attached to the lower end of the V and a pivotally attached rattle bait at the top end of the V. This contrasts with the present invention which includes a rigidly connected hook at each end of the V-shaped lure.

U.S. Pat. No. 9,339,019 for FISHING LURE DEVICE by Dages teaches a v-shaped frame with an eye at the vertex of the view.

### SUMMARY OF THE INVENTION

A fishing lure including a generally V-shaped frame having a long bottom first leg and a short top second leg. An eye or attachment loop is formed at the vertex of the V for attachment to a line or leader. A lure body extends at a selected obtuse angle from the end of the long bottom first leg wherein a fishing hook extends from the distal rear end of the lure body curving upward with the point curved over and toward the rear end of the lure body. A skirt is attached to the medial collar portion of the lure body after the head between the main body portion and distal end or tail of the lure. When a fishing line is attached to the eye or loop the lure body is positioned in the horizontal plane and the longer leg extends forward and upward therefrom. The shorter leg extends rearwardly a selected length wherein the distal end of the rear leg is nearly over the distal end of the longer bottom leg; however, the top leg can be shorter or longer and is not critical depending upon whether a hook or spoon blade is attached to the distal end of the top short leg.

The point of novelty lies in the transverse members comprising wires or polymer longitudinal members defining antennae extending from the front tip of the integral or unitary fish head and body. The transverse antennae are spaced apart at selected angles and have selected lengths. The antennae include leaders attaching to the distal end by rotatable leaders connecting to a rotating fish attracting articles such as a spoon which is generally a metallic or reflective member. Moreover, in a preferred embodiment, the transverse antennae extend forward and sideways at a selected angle of between about 25 and 85 degrees.

In one preferred embodiment shown in FIGS. 7-36, the top and bottom antennae extend outwardly from the side from a horizontal line drawn through the main body at a selected angle at approximately from 25 to 35 degrees and more particularly about 30 degrees. The top antennae extends upwardly from a horizontal line drawn through the main body at a selected angle at approximately from 50 to 70 degrees and more particularly about 65 degrees. The bottom antennae extends downwardly from a horizontal line drawn through the main body at a selected angle at approximately from 20 to 50 degrees and more particularly about 35 degrees. The top antennae extends outwardly from the side of the main body at a selected angle at approximately 15 to 35 degrees and more particularly about 20 degrees from a line drawn normal to the lure body axis. The bottom antennae extends forward from the main body at a selected angle at approximately from 25 to 65 degrees and more particularly about 45 degrees.

The first and second legs forming the V-shaped frame are formed from a single length of wire, polymer or other synthetic material bent at a selected angle of less than 120 degrees in order that the distal ends are spaced apart from one another and are oriented vertically one above the other when the lure is pulled through the water. A preferred embodiment includes a vertex angle of from 60 to 120 degrees and more preferably form 90 to 120 degrees, and more preferably the vertex legs may include an obtuse angle at the proximate end of one of the legs extending forward toward the eye and an second angle of less than 180 degrees rearward toward the hook so that the combination of the angles of the selected leg (usually the shorter top leg) is approximately at a right angle of about 90 degrees with respect to the long bottom leg.

A pair of transverse wires or synthetic longitudinal members extend from the front portion or tip of the lure body, more particularly from the head extending perpendicular or normal to the lure body. The transverse wires are spaced apart from one another at one or more selected angles and lengths forming whiskers extending outwardly pass the lure body. It is also contemplated that the transverse wires or whiskers could rotate around a spindle like a propellor. In a first preferred embodiment, a spoon or other type of blade is rotatably attached to the distal end of each of the transverse longitudinal members or whiskers. The spoons or blades rotate upon the bait being pulled through the water to replicate a school of scad moving around the lure body. In one preferred embodiment, a distal end loop extends from the top short leg and each of the whiskers or transverse longitudinal members. A rotatable leader including a first loop of wire is connected to each distal end loop and a rotatable wire loop attaches the spoon blade to the distal end of the wire leader. Thus, the lure includes a rotatable top blade, and a plurality of transverse blades extending from the whiskers. The embodiment shown in the drawings include four transverse blades.

In a second embodiment which includes all of the features of the first embodiment, the top leg includes a coaxially mounted spacer such as a bead resting on the proximate end adjacent the eye or attachment loop. A clevis or other means of attachment connects a medial spoon blade to the leg whereby the spoon blade can move from side to side or up and down a fixed distance along the clevis. A second bead spacing member is disposed on the leg after the clevis. A cylindrical member such as a sleeve or spring is mounted coaxially on the short leg adjacent the second bead spacer member and a third bead spacer member is mounted after the sleeve and before the loop on the distal end of the top short leg. The beads and sleeves cover a selected portion of the second top leg and are free to move axially along the leg. A rotatable spoon blade extends from the distal end of the second top leg and over the lure body. Thus, the lure includes a rotatable top blade, a medial blade, and a plurality of transverse blades extending from the whiskers. The embodiment shown in the drawings include four transverse blades.

It is an object of this invention to provide a fishing lure which mimics the movements and motion of live bait within a school of Shad as the lure is pulled through the water.

It is an object of this invention to provide a fishing lure which is weighted and balanced in such a way as to maintain a smooth lifelike movement through the water.

It is an object of this invention to provide a fishing lure which includes a V-shaped frame with an eye at the vertex for connecting to a fishing line and rotatable blades attached at each distal end of the V-shaped frame.

It is an object of this invention to provide a fishing lure wherein the junction between the hook and one end of the V-shaped frame includes at least one pair of transverse longitudinal members or leaders forming whiskers extending from the tip or front portion of the lure body perpendicular thereto with rotatable blades extending from the distal ends thereof.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a perspective view of the fishing lure including a spaced apart pairs of transverse members such as wires defining antennae transverse to the axis and radially attached to the front end of a lure body including a medial angle forming distal trailing end segments spaced apart from the lure body for attachment of fish attraction articles such as spoons attaching to the distal ends thereof with rotatable leaders;

FIG. 2 is a front view of the fishing lure of FIG. 1;

FIG. 3 is a rear view of the fishing lure of FIG. 1;

FIG. 4 is a perspective side view of an embodiment of FIG. 1 showing an attachment notch at a junction of a first top leg and a second bottom leg joined at the vertex and a spoon rotatably attached to the distal end of the first top leg;

FIG. 5 is a top view of the fishing lure of FIG. 4 showing the transverse longitudinal antennae members and a propeller spindle with an optional blade or blade segment on the antennae members;

FIG. 6 is a bottom view of the fishing lure of FIG. 4 showing the skirt extending from the lure body covering the hook and first top leg spoon; and

FIG. 7 is a perspective side view of an embodiment of the fishing lure including a pair of transverse longitudinal antennae top members having a first proximate segment extending upwardly, outwardly, and forwardly at selected angles; a pair of transverse longitudinal antennae bottom members having a first proximate segment extending upwardly, outwardly, and forwardly at selected angles; each pair of top members and bottom members having a second distal segment extending rearwardly therefrom at a selected medial angle of about 90 degrees which is in parallel alignment with the lure body axis, and a rotatable leader with a fish attracting articles such as a spoon attaching to the distal end of each distal segment wherein the transverse members are pivotally attached to the front end center attachment point and the transverse members include a flat, angled or curved surface portion defining a blade angle for promoting rotation of the transverse members about the axis when pulled through the water.

### DESCRIPTION OF THE PREFERRED EMBODIMENT

A fishing lure 10 including a generally V-shaped frame having a short top first leg 14 and a long bottom second leg 16. An eye or attachment loop 12 is formed at the vertex of the V for attachment to a line or leader. A lure body 20 extends at a selected angle from the distal end 17 of the long bottom second leg 16 wherein a fishing hook 32 extends from the rear end 21 of the lure body 20 curving upward with the point 31 curved over and toward the rear end of the lure body 20. Dimples or generally oval shaped depressions 26 depict eye balls on the forward portion of the lure head. A skirt 42 is attached to the medial collar portion 21 of the lure body after the integral head and main body 20 and distal end or tail of the lure 10. When a fishing line is attached to the eye or loop the lure body 20 is positioned in the horizontal plane and the shorter top leg 16 extends rearward and upward therefrom. The shorter leg 14 extends rearwardly a selected length wherein the distal end of the rear leg is nearly over the distal end of the longer bottom leg; however, the top leg can be shorter or longer and is not critical depending upon whether a hook or spoon blade is attached to the distal end of the top short leg:

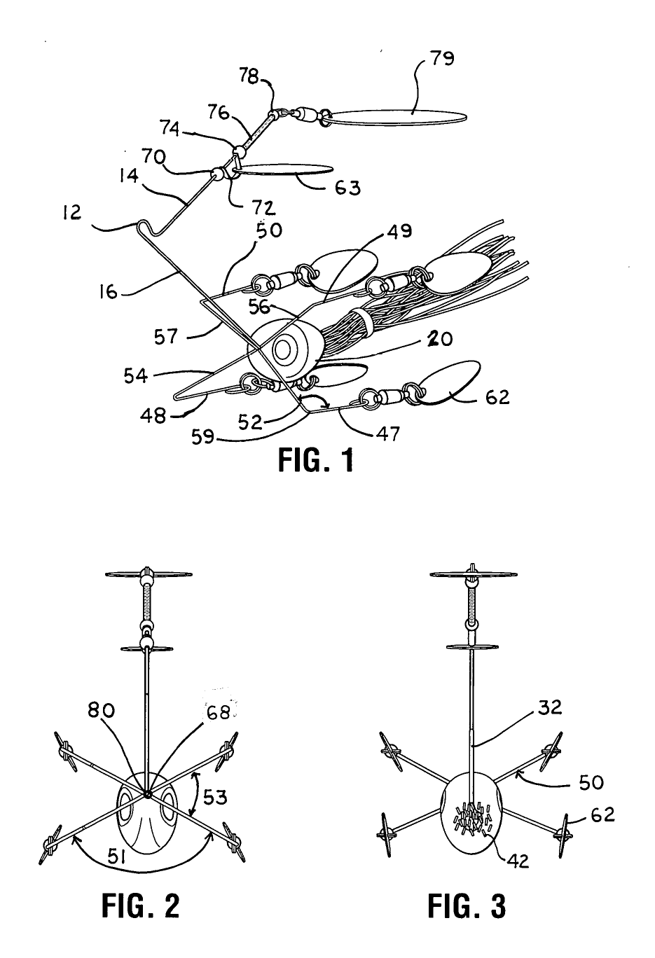

The fishing lure 10 as shown in FIGS. 1-6, includes an approximately V-shaped element positioned as an arrow pointing to the left with a first top leg 14 extending upward and a second bottom leg 16 extending downward in alignment with one another. The top first leg 14 is of a shorter length than the second lower leg 16. The first leg 14 and second leg 16 disposed at a selected angle from one another of about 30 to 90 degrees and more preferably from about 35 to 65 degrees and more preferably from about 35 to 50 degrees and more preferably from about 40 to 45 degrees and as shown in the embodiment of FIG. 1 about 45 degrees. A lure body 20 with a single hook is rigidly attached to the body 20. The hook 32 is coplanar with the V-shaped element. The eye 12 for attaching a fishing line is at the vertex of the V-shaped element.

A fish hook known as a ‘bait hook’ includes a straight portion called a shank 45, a bend 54, a barb 46 and a point 58. The barb 56 helps to hold the bait onto the hook and helps to hold the fish onto the hook once the fish has been hooked. Because the hook 32 is rigidly attached to the body 20 by welding, soldering, silver soldering, or integrally formed with the body.

With reference to the figures, leg 14 is about three-fourths as long as leg 16. The V-shaped element is shown vertical with the vertex pointing to the left. The hook 21 is oriented trailing to the right with the point located above the shank. An approximately tear drop shaped lure body 20 extends from the distal end of the leg 116. The lure body 20 tapers to a point at the rear and forms a neck 21 which encircles the proximate portion of the shank 45. A lip or rear rim 22 having a greater diameter than the neck 21 extends radially outward from the rear end of the neck 21 surrounding the shank 45. A front rim 23 having a larger diameter than the neck 21 may also be disposed behind the body 20. The elastic portion of the skirt or an elastic band is securely held into position between in front of the rear rim 22.

A skirt 42 includes a gathered portion or front sleeve portion 25 which is stretched over the rim 22 and over the neck 21. Retaining means 44 such as an elastic band, rubber band, plastic clamp, metal clamp, can be fitted over the sleeve of the neck to retain the skirt thereon. The skirt may also be formed having an stretchable or elastic front sleeve portion 25 integrally formed therewith for securing the skirt to the neck. The strips or strings of the shirt extends over and covers the hook and/or bait on the hook. It is contemplated that an alternate type of bait may be substituted for the skirt and attached to the hook. Elastomeric baits such as artificial worms, fish, tadpoles, various insects, feathers, skirts and the like are applied to hook 32 of lure 10 to form a complete lure.

It is thought that the nature of the rigid attachment of the hooks to the fishing lure frame 10 provides a smooth lifelike schooling image to fish in that, as the lure is pulled through the water, the leading ends, usually the heads, of the baits move simultaneously and always in the same direction, thus imparting a synchronized motion to the rest of the bodies of the baits. This synchronized motion of the baits generally mimics the movement of a school of fish.

In a first preferred embodiment the first and second legs forming the V-shaped frame are formed from a single length of wire, polymer or other synthetic material bent at a selected angle of less than 120 degrees in order that the distal ends are spaced apart from one another and are oriented vertically one above the other when the lure is pulled through the water. A preferred embodiment includes a vertex angle of from about 60 to 120 degrees and more preferably from about 90 to 120 degrees, and more preferably the vertex legs may include an obtuse angle at the proximate end of one of the legs extending forward toward the eye and an second angle of less than 180 degrees rearward toward the hook so that the combination of the angles of the selected leg (usually the shorter top leg) is approximately at a right angle of about 90 degrees with respect to the long bottom leg. As used herein, the term “about” can be reasonably appreciated by a person skilled in the art to denote somewhat above or somewhat below the stated numerical value, to within a range of +10%.

A plurality of transverse wires or synthetic longitudinal members 52, 54, 56, and 57 extending radially from the front portion 24 or tip of the lure body, more particularly from the head extending perpendicular or normal to the lure body. The transverse members 52, 54, 56, and 57 are spaced apart from one another at one or more selected angles and lengths forming whiskers extending outwardly pass the lure body. It is also contemplated that the transverse wires or whiskers could rotate around a spindle like a propellor. As shown in the figures, the top two transverse members 56 and 57 are of the same length as the bottom two transverse members 52, 54; however, it is contemplated that the lower transverse members could be shorter or longer than the top transverse members 56 and 57. The top transverse members 56 and 57 are the same length. The bottom transverse members 52 and 54 are of the same length. The lure embodiment shown in FIG. 2 shows an angle 51 between the two top transverse members 56 and 57 is about 135 degrees and typically in a range of from about 25 to 135 degrees forming an obtuse angle. The angle 53 between each top transverse members 52, 54 and the bottom transverse members 56, 57 is typically an acute angle of about 35 degrees and ranges from about 25 to 135 degrees. Another preferred embodiment spaces the top transverse members 56 and 57 apart from one another and the bottom transverse members 52 and 54 at about the same angle of about 45 degrees along the longitudinal axis when looking at the front of the lure.

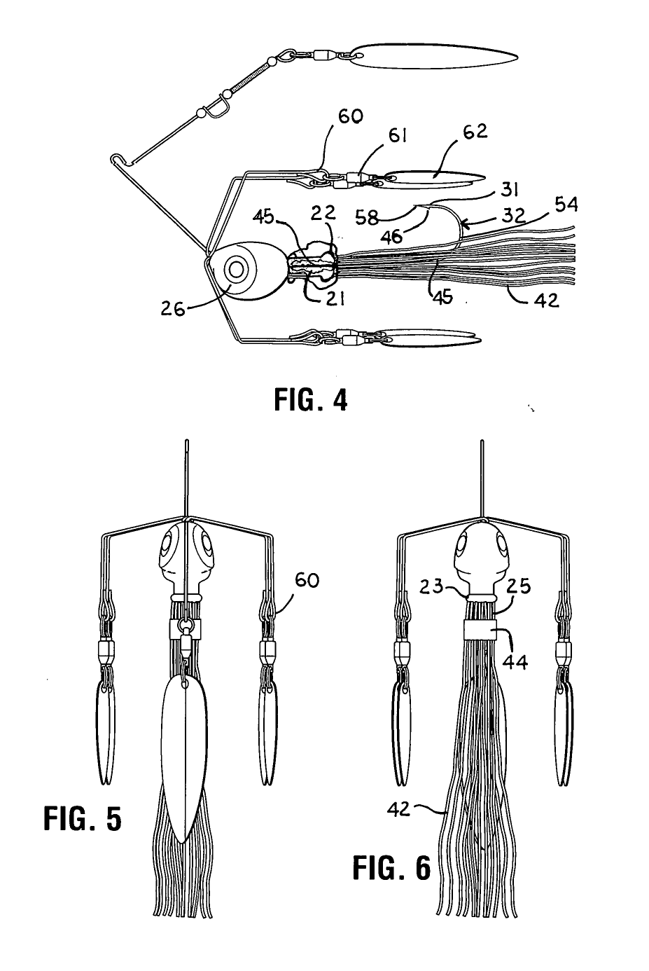

The transverse members, 52, 54, 56, and 57 extend outward in a plane perpendicular or transverse to the axis of the elongated lure body. Each of the transverse members 52, 54, 56, and 57 define a proximate transverse segment extending from a front end center attachment point 68 on the main body 20 at about a 90 degrees angle. The individual transverse members are immovably attached to the front end center attachment point by holding means 80 such as riveting, glueing, a pin (as shown in FIG. 3), threaded member, insertion into the body by a friction fit (as shown in FIG. 4). It is contemplated that the transverse members may be formed within or attached to the lure body by placing the transverse members in a mold used to form the lure body from a plastic material. One preferred embodiment as shown in the drawings, includes a distal trailing segment extends from each one of the proximate transverse segments at a selected angle 59 of between about 90 and 180 degrees. As shown in FIGS. 1 and 4-6, distal trailing segment 47 extends from transverse member 52, distal trailing segment 48 extends from transverse member 54, distal trailing segment 49 extends from transverse member 56, and distal trailing segment 50 extends from transverse member 57.

A point of novelty lies in the transverse members comprising wires or polymer longitudinal members defining antennae extending from the front tip of the integral or unitary fish head and body. The transverse antennae are spaced apart at selected angles and have selected lengths. The antennae include leaders attaching to the distal end by rotatable leaders connecting to a rotating fish attracting articles such as a spoon which is generally a metallic or reflective member. Moreover, the transverse antennae may also extend forward at a selected angle of between about 25 and 85 degrees.

FIGS. 1-7 show embodiments of the fishing lure including a pair of transverse members defining longitudinal antennae having a proximate segment extending upwardly, outwardly, and rearwardly at selected angles. The transverse members forming the longitudinal antennae comprising the bottom segment are of a selected length extending outwardly and rearwardly at selected angles. Each pair of top members and bottom members having a second distal end segment of a selected length extending rearwardly therefrom at a selected medial angle of about 90 degrees which is in parallel alignment with the lure body axis. A rotatable leader 61 with a fish attracting article 62 such as a spoon or bait attaches to a means of attachment 60 such as a loop extending from the distal end segments 47, 48, 49, and 50 too spin freely thereabout.

The spoon or other type of blade 62 is rotatably attached to the distal end of each of the transverse longitudinal members or whiskers. The spoons or blades rotate upon the bait being pulled through the water to replicate a school of scad moving around the lure body. In one preferred embodiment, a distal end loop extends from the top short leg and each of the whiskers or transverse longitudinal members. A rotatable leader including a first loop of wire is connected to each distal end loop and a rotatable wire loop attaches the spoon blade to the distal end of the wire leader. Thus, the lure includes a rotatable top blade, and a plurality of transverse blades extending from the whiskers. The embodiment shown in the drawings include four transverse blades.

In a second embodiment which includes all of the features of the first embodiment, the top leg 14 includes a coaxially mounted spacer such as a bead 70 resting on the proximate end adjacent the eye or attachment loop. A clevis 72 or other means of attachment connects a medial spoon blade to the leg 14 whereby the spoon blade 61 affixed to the clevis 72 can move from side to side or up and down a fixed distance along the upper leg 14. A second bead 74 spacing member is disposed on the leg 14 after the clevis 72. A cylindrical member 76 such as a sleeve or spring is mounted coaxially on the short leg 14 adjacent the second bead spacer member 74 and a third bead spacer member 78 is mounted after the sleeve 76 and before an attachment means such a loop 77 on the distal end 75 of the top short segment 14. The beads and sleeves cover a selected portion of the second top leg and are free to move axially along the leg. A rotatable top spoon blade 79 extends from a leader 61 extending from the distal end of the top leg 14 and over the lure body. The lure includes a rotatable top blade 79, a medial blade 63, and a plurality of transverse blades or spoons 62 extending from the antennae or whiskers. The embodiment shown in FIG. 1 includes four transverse blades.

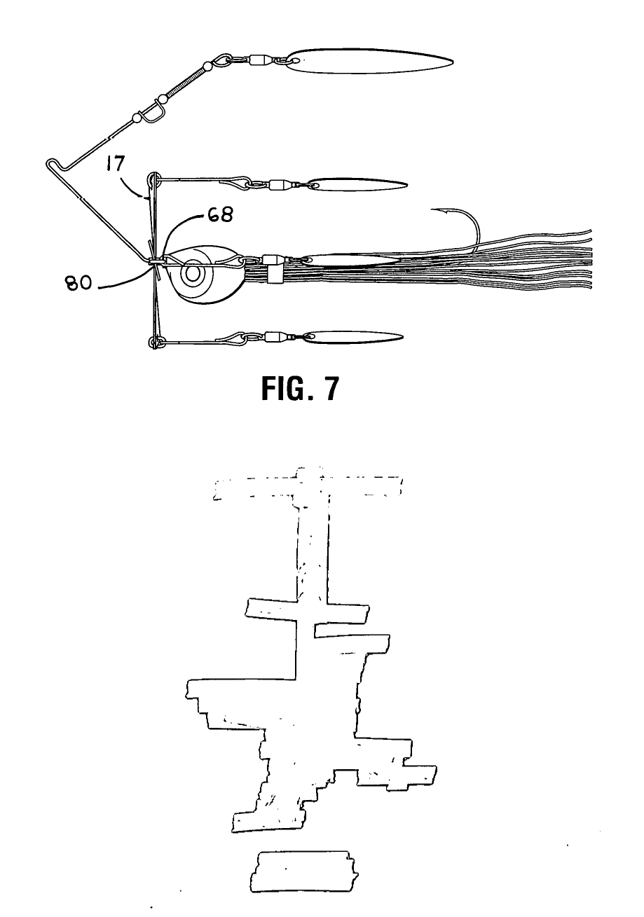

It is also contemplated that the transverse wires or whiskers can rotate around a spindle 80 like a propellor. FIG. 7 shows the transverse members mounting to a spindle 80 rotatably supported at a front end center attachment point 68 wherein the transverse members 52, 54, 57, and 59 include an optional blade or blade segment 17 to invoke rotation of the transverse members which spin when the lure is pulled through the water.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

I claim:

1. A fishing lure frame comprising:
a V-shaped frame having an aperture or loop formed at a vertex of said V-shaped member, said V-shaped member having a first leg and an upper second leg joined at said vertex, said first leg including a lure body extending from a distal end thereof with a hook extending from a distal end of said body and a skirt attaching at a collar formed by a reduced diameter medial portion of said body, said second leg being about three-fourths as long as said first leg and extending at a selected angle of from between 60-120 degrees from said first leg, said second leg extending in spaced apart alignment with said first leg and said second leg including a rotatable bladed attaching to a distal end thereof, said lure body including a plurality of spaced apart transverse longitudinal members extending from a front end center attachment point of said lure, each one of said transverse longitudinal members including a trailing distal end segment extending therefrom at a selected angle of about 90 degrees and in parallel alignment with the axis of said lure and said trailing distal end segment including a distal end having an attachment means extending therefrom connecting to a rotatable leader having a fish attracting article.

2. A fishing lure frame comprising:
a V-shaped frame having an aperture or loop formed at a vertex of said V-shaped member, said V-shaped member having a first leg and an upper second leg joined at said vertex, said first leg including a lure body extending from a distal end thereof with a hook extending from a distal end of said body and a skirt attaching at a collar formed by a reduced diameter medial portion of said body, said second leg being about three-fourths as long as said first leg and extending at a selected angle of from between 60-120 degrees from said first leg, said second leg extending in spaced apart alignment with said first leg and said second leg including a rotatable bladed attaching to a distal end thereof, said lure body including a plurality of transverse longitudinal members extending from the tip thereof including distal ends having rotatable blades connecting thereto;
said upper leg including a coaxially mounted spacer such as a bead resting on the proximate end adjacent the eye or attachment loop, a clevis or other means of attachment connects a medial spoon blade to the leg whereby the spoon blade can move from side to side or up and down a fixed distance along the clevis, a second bead spacing member is disposed on the leg after the clevis, a cylindrical member such as a sleeve or spring is mounted coaxially on the short leg adjacent the second bead spacer member and a third bead spacer member is mounted after the sleeve and before the loop on the distal end of the top short leg, said beads and sleeves covering a selected portion of the second top leg and are free to move axially along the leg, a rotatable spoon blade extending from the distal end of the second top leg and over the lure body, wherein said lure includes a rotatable top blade, a medial blade, and a plurality of transverse blades extending from the whisker; and
a pair of transverse longitudinal antennae top members having a first proximate segment extending upwardly, outwardly, and forwardly at selected angles; a pair of transverse longitudinal antennae bottom members having a first proximate segment of a selected length extending upwardly, outwardly, and forwardly at selected angles; each pair of top members and bottom members having a second distal segment of a selected length extending rearwardly therefrom at a selected medial angle which is in parallel alignment with the lure body axis; and a rotatable leader with a fish attracting article such as a spoon or bait attaching to the distal end of each second distal segment.
